(19) United States
(12) Patent Application Publication
(10) Pub. No.: US 2013/0160419 A1
(43) Pub. Date: Jun. 27, 2013

(54) ATTACHMENT FOR CROP LIFTER

(71) Applicant: RALPH MCKAY INDUSTRIES INC., Regina (CA)

(72) Inventors: Dwayne Arthur Chychrun, Regina (CA); Glen Alvin Anthony Yanko, Regina (CA)

(73) Assignee: RALPH MCKAY INDUSTRIES INC., Regina (CA)

(21) Appl. No.: 13/721,899

(22) Filed: Dec. 20, 2012

(30) Foreign Application Priority Data
Dec. 23, 2011 (CA) 2762746

(51) Int. Cl. A01D 65/02

(52) U.S. Cl. CPC A01D 65/02
USPC 56/312

(57) ABSTRACT

A crop lifter apparatus is provided that is adapted for attachment to a cutting header. The apparatus can have a guard member having a slot passing through it, a latch member pivotally attached at a first end to the guard member and having an aperture for receiving a guard bolt on the cutting header, the aperture passing through a side edge of the latch member, a ski member operatively attached to the guard member, and a lifting arm attached to the ski member. To attach the crop lifter apparatus to a cutting header, the crop lifter can be positioned on the guard bolt with the guard bolt extending into the slot in the guard member. The latch can then be pivoted so that the aperture in the latch is positioned on the guard bolt or spool. This can attach the crop lifter apparatus securely to the cutting header.

The present invention relates to agricultural harvesting implements and in particular to an attachment for attaching a crop lifter to a cutting header.

### BACKGROUND

Crops such as grains, beans, hay, and the like are cut at harvest using a cutting header. Typically the knife on a cutting header comprises a knife bar extending along the front lower edge of the header, with triangular knife sections extending forward from the bar. The exposed side edges of the knife sections are sharpened and move laterally back and forth, cooperating with guards attached to the front lower edge of the header to slice the crop stems.

The guards comprise pointed guard fingers extending forward, and the knife moves back and forth along the edge of the header in a slot cut laterally through the guard fingers. In addition to cooperating with the knife to cut the crop, the guards serve to protect the knife sections from breakage when contacting stones and other obstructions.

Crops sometimes are lying close to the ground making them difficult to cut. Some plants are inherently short, while others may fall down when they reach maturity, or be pushed down by heavy rain or hail.

The knife of a conventional cutting header is a few inches above the ground when the header is in its lowest position, such that very short or downed crop material will pass under the knife and be lost. Crop lifters of various kinds have been developed that are attached to the header and provide a ski member that extends forward from the knife and rides along the ground ahead of the knife, following the ground and moving up and down relative to the knife as the orientation of the header with respect to the ground varies with field contours. A lifting arm extends rearward at a shallow angle from the front of the ski member back and over the knife. The front end of the ski member slides under the crop stems and lifts them up and they then slide rearward along the top of the lifting arm and over the knife to be cut and fall onto the header.

These crop lifters are typically attached to a cutting header by the guard fingers and a guard bolt. Often they are bolted on to the guard fingers of the cutting header requiring tools and a quite some time to attach to the cutting header. Because of the length of the average cutting header, numerous crop lifters may be attached to a single cutting header compounding the time and trouble to attach all of the crop lifters to a cutting header. There are some mechanisms to provide a quick attach feature to the crop lifters. However, these mechanisms must be relatively easy to attach yet still connect the crop lifter securely enough to the cutting heard so that they do not become unattached while the cutting header is in use.

### SUMMARY OF THE INVENTION

A crop lifter apparatus adapted for attachment to a cutting header is provided. The apparatus can have: a guard member having a slot passing through a rear end of the guard member; a latch member pivotally attached at a first end to the guard member and having an aperture for receiving a guard bolt on the cutting header, the aperture passing through a side edge of the latch member; a ski member operatively attached to the guard member; and a lifting arm attached to the ski member.

In another aspect, a crop lifter apparatus adapted for attachment to a cutting header is provided. The apparatus can have: a guard member having a slot passing through a rear end of the guard member; a latch member pivotally attached at a first end to the guard member and having an aperture for receiving a guard bolt on the cutting header, the aperture passing through a side edge of the latch member; a ski member operatively attached to the guard member; and a lifting arm attached to the ski member. The apparatus can be attached to a cutting header by pivoting the latch member to an open position and inserting a guard bolt in the slot in the guard member, then pivoting the latch member to a closed position with the guard bolt received in the aperture in the latch member.

In a further aspect, a securing member can also be provided. The securing member can have a first aperture for receiving a pin on the guard member and a second aperture for receiving the guard bold. The securing member can be inserted between the guard member and the latch member to aid in securing the apparatus to a cutting header.

In another aspect, a crop lifter apparatus adapted for attachment to a cutting header is provided. The apparatus can have: a guard member having a slot passing through a rear end of the guard member; a first latch member and a second latch member with both the first latch member and the second latch member pivotally connected to the guard member, the first latch member having a first aperture and the second latch member having a second aperture; a ski member operatively attached to the guard member; and a lifting arm attached to the ski member. The apparatus can be attached to a cutting header by pivoting the first latch member and the second latch member to an open position and inserting a guard bolt in the slot in the guard member, then pivoting the first latch member and the second latch member to a closed position with the guard bolt received in the first aperture in the first latch member and the second aperture in the second latch member.

### DESCRIPTION OF THE DRAWINGS

A preferred embodiment of the present invention is described below with reference to the accompanying drawings, in which:

FIG. 1 illustrates a side view of a crop lifter apparatus and a cutting header;

FIG. 2 illustrates a side view of the crop lifter apparatus in FIG. 1 attached to the cutting header;

FIG. 3 illustrates a top view of the crop lifter apparatus and cutting header of FIG. 1 with a latch in a closed position;

FIG. 4 illustrates a top view of the crop lifter apparatus and cutting header of FIG. 1 with a latch in an open position;

FIG. 5 illustrates a rear view of the crop lifter apparatus of FIG. 1;

FIG. 5A illustrates an exploded view of a guard bolt before it is inserted in a spool and held in place with a nut;

FIG. 5B illustrates a top view of the spool;

FIG. 6 illustrates an alternate crop lifter apparatus;

FIG. 7 illustrates a further crop lifter apparatus;

FIG. 8 illustrates a side view of a crop lifter apparatus using a securing member to aid in securing the crop lifter apparatus to a cutting header;

FIG. 9 illustrates a side view of the crop lifter shown in FIG. 8;

FIG. 10 illustrates a top view of the securing member;

FIG. 11 illustrates top view of the crop lifter apparatus of FIG. 8 with the securing member in position and the latch pivoted outwards;

FIG. 12 illustrates a side view of a crop lifter apparatus in another aspect having a first latch and a second latch;

FIG. 13 illustrates a top view of the crop lifter apparatus of claim 12 with the first latch and the second latch in an open position; and

FIG. 14 illustrates a top view of the crop lifter apparatus of claim 12 with the first latch and the second latch in a closed position.

### DETAILED DESCRIPTION OF THE ILLUSTRATED EMBODIMENTS

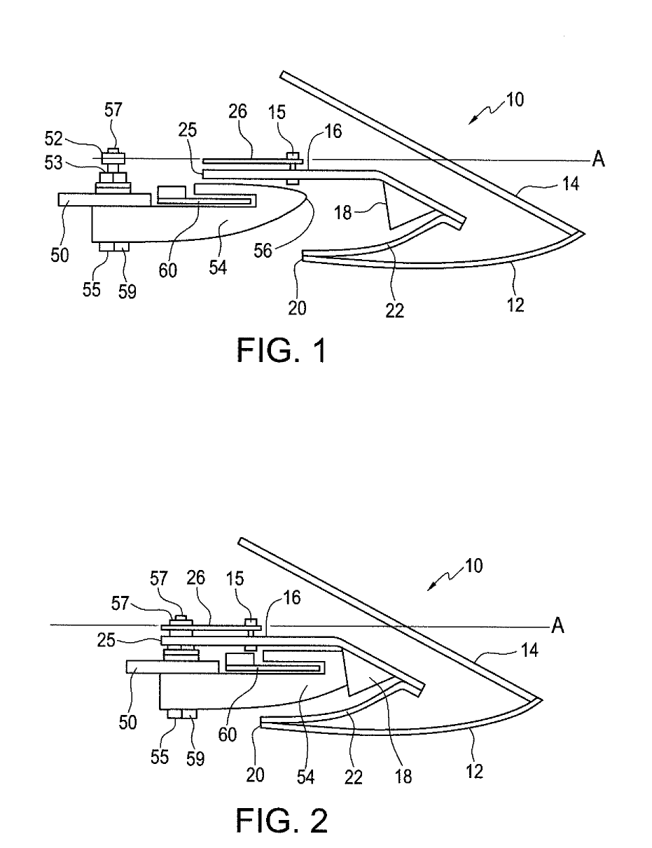

FIGS. 1-5 illustrate a crop lifter apparatus 10 in one aspect. The crop lifter apparatus 10 is attached in front of a cutting header 50 of a harvesting implement such as a combine, mower, or the like (not shown). The apparatus 10 can include a ski member 12 having a bottom surface configured for travelling along a ground surface in front of a harvesting implement and a lifting arm 14 for lifting crop material from the ground surface and directing the crop material into the cutting header 50.

The apparatus 10 can be attached by a guard member 16 to a guard bolt 55 provided on a guard finger 54 of the cutting header 50. The guard member 16 can have a finger recess 18 that is configured to receive a forward end 56 of a guard finger 54. When the apparatus 10 is moved towards the cutting header 50 for attachment to the cutting header 50, the forward end 56 of the guard finger 54 is received in the finger recess 18.

The ski member 12 is attached at a rear end 20 of the ski member 12 to a ski mounting plate 22 and extends forward under the ski mounting plate 22 and curves upward at a front end thereof. The ski mounting plate 22 serves to connect the ski member 12 and the guard member 16. The ski mounting plate 22 can extend rearwards and downwards from the finger recess portion 18, extending under the guard finger 54 when the guard finger 54 is inserted into the finger recess portion 18 as shown in FIG. 2.

The lifting arm 14 extends rearward from the front end of the ski member 12 back and over a knife 60 of the cutting header 50 when the apparatus 10 is attached to the guard finger 54. The ski member 12 and the ski mounting plate 22 are configured to flex. The ski mounting plate 22 and ski member 12 can be made of flexing spring steel for example.

The crop lifter 10 is attached to the cutting header 50 to extend forward from the cutting header 50 and follow the ground ahead of the cutting header 50. Crop material that is picked up off of the ground surface is directed by the lifting arm 14 over the knife 60 to be cut and fall onto the header.

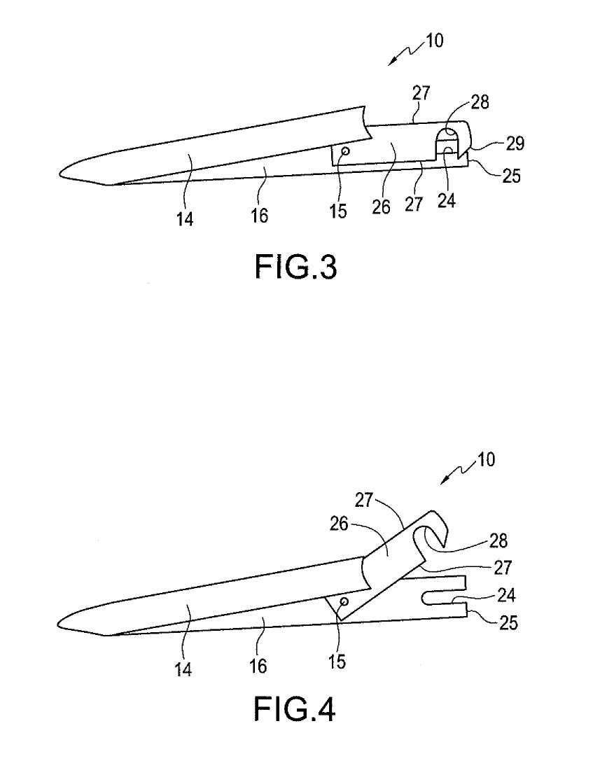

Referring to FIGS. 3 and 4, the guard member 16 can have an slot 24 that passes through a rear end 25 of the guard member 16. A latch 26 can be provided, pivotally attached to the guard member 16 with pivot point 15. The latch 26 can be pivotally attached at one end to the guard member 16 by means of a pivot point 15. This pivot point 15 could be a bolt, rivet, etc. In this manner, the latch 26 can pivot in a scissoring motion relative to the guard member 16 with the latch pivoting in a plane A (shown in FIGS. 1 and 2) that is substantially parallel to the guard member 16.

The latch 26 can have side edges 27 and an aperture 28 that passes through the latch 26 and one of the side edges 27 of the latch 26. A securing flange 29 can extend from the latch 26.

To connect the apparatus 10 to the cutting header 50, the latch 26 can be pivoted to one side in an open position as shown in FIG. 4 with a second end of the latch 26 pivoted away from the guard member 16. With the latch 26 in the open position, the apparatus 10 can be moved towards the cutting header 50 until the slot 24 in the guard member 16 is slid around the guard bolt 55. The latch 26 can then be moved to a closed position by pivoting the latch 26 over top of the guard member 16 and the guard bolt 55 securing the apparatus 10 in place. The latch 26 allows the apparatus 10 to be quickly attached and removed from the cutting head 50 without requiring any special tools.

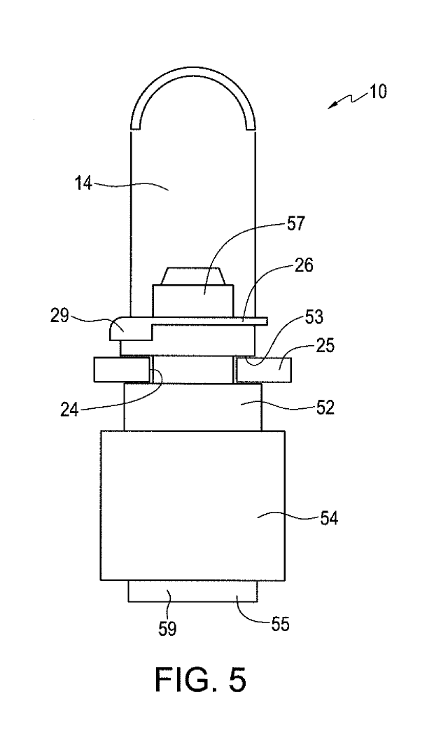

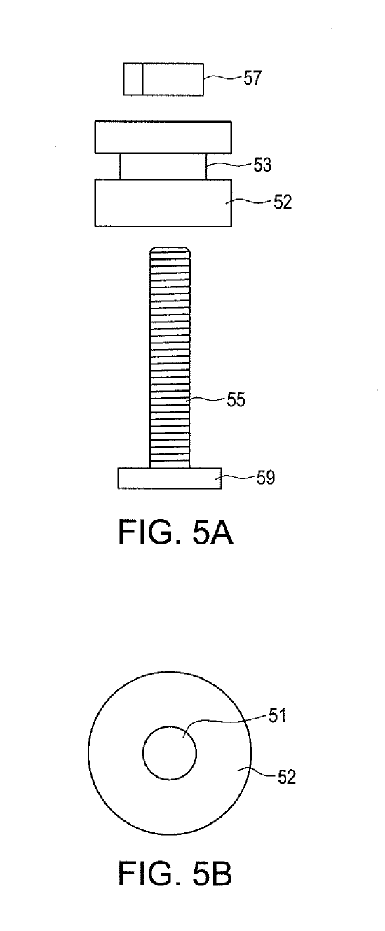

In one aspect, the guard bolt 55 can be used to attach a spool 52 to the guard finger 54 and the apparatus 10 can then be attached to the spool 52. FIG. 5A shows an exploded view of the guard bolt 55 before it is inserted through the spool 52 and a nut 57 for securing the guard bolt 55 in the spool 52. The spool 52 can be attached to the finger guard 54 of the cutting header 50 by the guard bolt 55 and a nut 57. The guard bolt 55 can be inserted through an internal bore 51 (shown in FIG. 5B) in the spool 52 and the nut 57 used to secure the guard bolt 55 in place within the spool 52. When the spool 52 is attached to the finger guard 54, the head 59 of the guard bolt 55 can extend below the finger guard 54 and the nut 57 can extend above the spool 52. The spool 52 can have a groove 53 and the slot 24 in the guard member 16 can be slid into the groove 53 of the spool 52. With the apparatus 10 positioned with the slot 24 of the guard member 16 in the groove 53 of the spool 52, the latch 26 can be pivoted over top of the spool 52 so that the nut 57 or the head 59 of the guard bolt 55 (depending on the orientation) can be received in the aperture 28 of the latch 16 as shown in FIG. 2. The securing flange 29 can be positioned so that it hooks over an edge of the spool 52, securing the latch 26 in the closed positioned. FIG. 5 shows a rear view when the apparatus 10 is attached to the spool 52.

The latch 26 and the aperture 28 in the latch 26 can be positioned relative to the guard member 16 so that the aperture 28 in the latch 26 and the slot 24 in the guard member 16 align when the latch 26 is in its closed position. In this manner, the spool 52 can pass through both the slot 24 in the guard member 16 and the aperture 28 in the latch 26 when the apparatus 10 is attached to the cutting header 50 and the latch 26 is in the closed position.

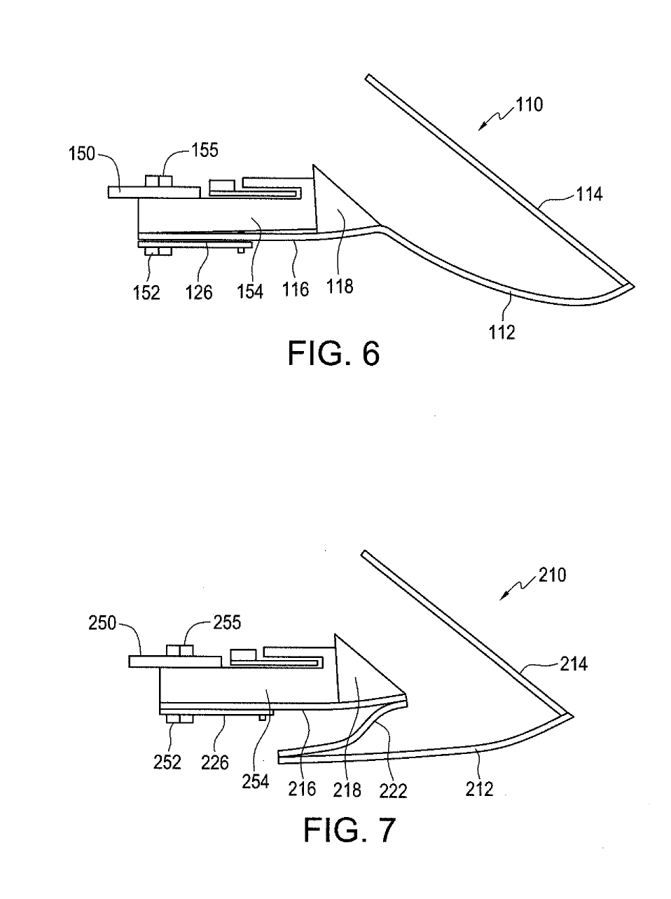

While the latch 26 is shown on a specific configuration of a crop lifter in FIGS. 1-5, a person skilled in the art would appreciate that the same type of attachment could be used with various other styles of crop lifters. FIG. 6 illustrates a more conventional crop lifter apparatus 110 with a ski member 112 that extends forwards from a guard member 116 and a finger recess portion 118. A lifting arm 114 can extend rewards from the front of the ski member 112. The apparatus 110 can be attached to a cutting header 150 by sliding the guard member 116 into a slot on a spool 152 and using a latch 126 to secure the apparatus 110 to the cutting header 150. The latch 126 can be similar to the latch 26 shown in FIGS. 1-5 on apparatus 10, with it pivoting, in a plane that runs substantially parallel to the guard member 116, between an open position where the crop lifter 110 can be removed from the cutting header 150 and a closed position where the latch 126 secures the crop lifter 110 to the guard member 116.

FIG. 6 shows a crop lifter apparatus 110 where guard member 116 attaches to a spool 152 held on by a guard bolt 155 and positioned below a guard finger 154 so that the latch 126 is positioned below the guard member 126. This orientation could also be used with a crop lifter similar to the crop lifter apparatus 10 shown in FIGS. 1-6. FIG. 7 illustrates a crop lifter apparatus 210 where a guard. member 216 is used to connect the crop lifter apparatus 210 to a cutting header 250. Similar to the crop lifter apparatus 10 shown in FIGS. 1-5, the crop lifter apparatus 210 can have a finger recess portion 218, a ski member 212, a ski mounting plate 222 attached between the guard member 216 and the ski member 212 and a lifting arm 214 extending from the ski member 212. Unlike the crop lifter apparatus 10, the crop lifter apparatus 210 can have the guard member 216 and a latch 226 positioned so they can be connected underneath a guard finger 254 to a spool 252 held onto the guard finger 254 by a guar bolt 255. Similar to latch 26 show in FIGS. 1-5, latch 226 can be pivoted relative to the guard member 226 between an open position, wherein the crop lifter apparatus 220 can be attached to the cutting header 250 and a closed position, wherein the crop lifter apparatus 220 is secured to the cutting header.

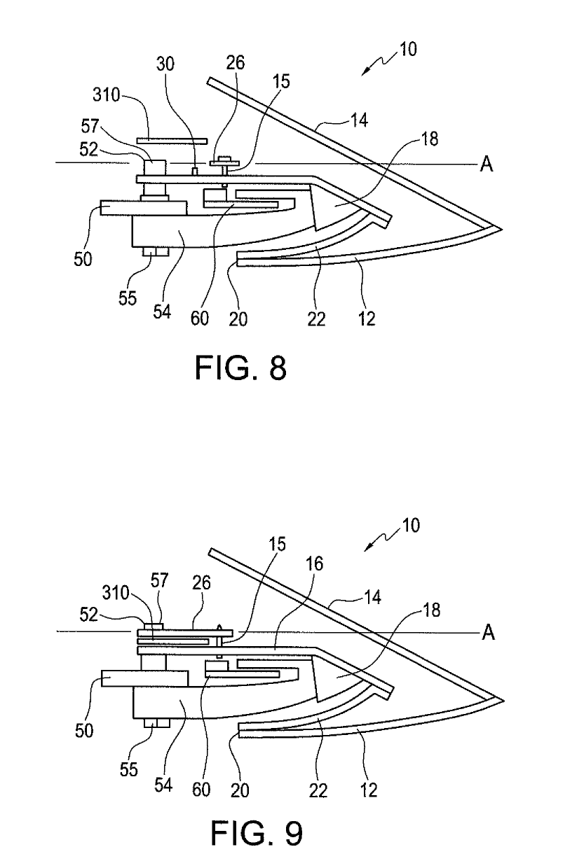

FIGS. 8-11 illustrate a further aspect of the crop lifter apparatus 10 where a securing member 310 can be provided to aid in securing the crop lifter apparatus 10 to the cutting header 50. The securing member 310 can be provided attached between the guard member 26 and the top of the spool 52 to help secure the guard member 26 to the spool 52. The latch 26 can be pivoted so that it pivots over top of the securing member 310 at attaches to the spool 52 so that both the securing member 310 and the latch 26 work together to secure the crop lifter apparatus 10 to the cutting header 50.

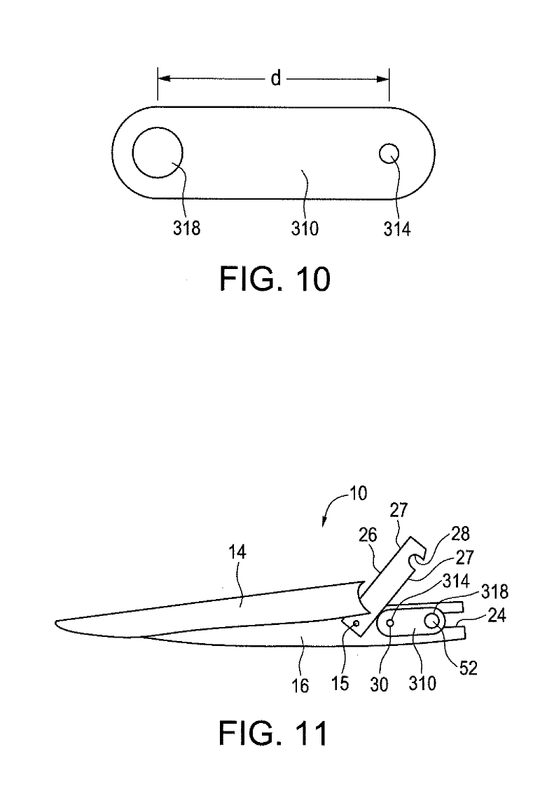

Referring to FIG. 10, the securing member 310 can include a first aperture 314 and a second aperture 318. The first aperture 314 can be sized to fit around a peg 30 extending upwards from a top surface of the guard member 16 of the crop lifter apparatus 10 (shown in FIG. 8). The peg 30 can be provided on the guard member 16 between the pivot point 15, where the latch 26 is pivotally connected to the guard member 16, and the slot 24 in the guard member 16. The peg 30 will extend upwards from the top surface of the guard member 16 but not extend so much that the latch 26 cannot be pivoted over top of the peg 30.

The second aperture 318 in the securing member 310 can be sized so that it fits around the top of the spool 52. The second aperture 318 is sized and positioned in the securing member 310 so that material forming the securing member 310 completely encircles the second aperture 318.

The first aperture 314 and the second aperture 318 in the securing member 310 can be spaced a defined distance, d, apart. This distance, d, can correspond with the distance between the peg 30 on the guard member 16 and the top of the spool 52 when the spool 52 is positioned in the slot 24 in the guard member 16.

Referring to FIGS. 8-11, to use the securing member 310 the latch 26 can be pivoted to one side and the apparatus 10 moved towards the cutting header 50 until the slot 24 in the guard member 16 is positioned around the spool 52. With the spool 52 in place in the slot 24 in the guard member 16, the securing member 310 can be positioned so that the peg 30 extending upwards from the guard member 16 is positioned in the first aperture 314 of the securing member 310 and the second aperture 318 is positioned over the head of the guard bolt 55 attaching the spool 52 to the cutting header 50, as shown in FIG. 11. In this manner, the securing member 310 will then be holding the crop lifter apparatus 10 in place on the cutting header 50, as shown in FIG. 9. With the securing member 310 in place, the latch 26 can be pivoted over top of the guard member 16 and the securing member 310 until the spool 52 (and more particularly the guard bolt 55 holding on the spool 52) is positioned in the aperture 28 in the latch 26 and the latch 26 is also securing the crop lifter apparatus 10 to the cutting head 50. In this manner, the securing member 310 will be positioned between the guard member 16 and the latch 26.

The securing member 310 and the latch 26 can work in conjunction to secure the crop lifter apparatus 10 to the cutting header 50. With the securing member 310 securing the cutting header 50 to the guard member 16 and the latch 26 both securing the cutting header 50 to the guard member 16 and holding the securing member 310 in place.

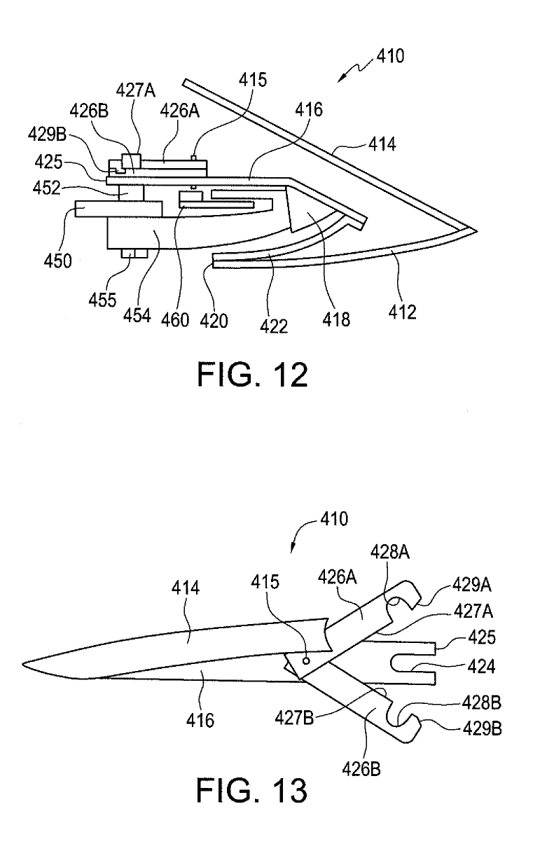

FIGS. 12-14 illustrate a crop lifter apparatus 410 in another aspect. Similar to the crop lifter 10 shown in FIG. 1-5, the crop lifter apparatus 410 can include a guard member 416, a finger recess portion 418, a ski member 412, a ski mounting plate 422 attached between the guard member 416 and the ski member 412, and a lifting arm 414 extending from the ski member 412. The guard member 416 can have a slot 424 passing through the back of back end 425 of the guard member 416.

The crop lifter apparatus 410 can connect to a spool 452, which in turn is connected to the guard finger 454 by a guard bolt 455 provided on the cutting header 50, with the spool 152 inserted in the slot 424 on the guard member 416 and the guard finger 154 inserted in the finger recess 418.

A first latch 426A and a second latch 42613 can be provided pivotally attached to the guard member 416 by a pivot point 415. The first latch 426A and the second latch 426B are positioned so that the first latch 426A and second latch 426B can be pivoted so that one is positioned over the other and both the first latch 426A and the second latch 426B can be positioned over the guard member 416.

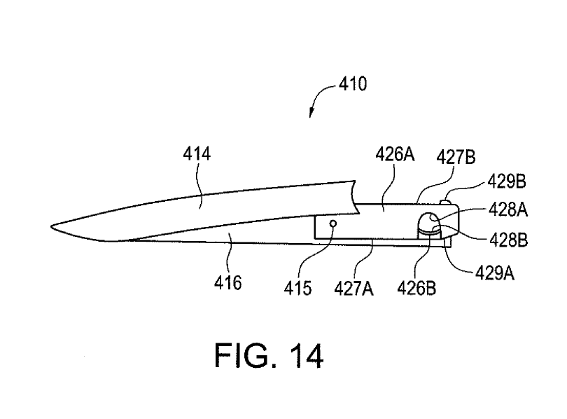

The first latch 426A can have a first side edge 427A and an aperture 428A that passes through the first side edge 427A of the first latch 426A. The second latch 426B can have a first side edge 427B and an aperture 428B that passes through the first side edge 427B of the second latch 426B. The aperture 428A in the first latch 426A and the aperture 428B in the second latch 426B can be positioned so that the apertures 428A, 428B and the slot 424 on the guide member 416 all align when the first latch 426A and the second latch 426B are both pivoted over the guard member 416, as shown in FIG. 14.

To attach the crop lifter apparatus 410 to the cutting header 450, the first latch 426A and the second latch 426B can be pivoted away from the guard member 416, as shown in FIG. 13, allowing the guard member 416 to be moved towards the cutting header 50 and the slot 424 positioned on the spool 452. With the spool 452 in position in the slot 424 in the guard member 416, the first latch 426A and the second latch 426B can be pivoted over top of the member guard 416, as shown in FIG. 14, so that the apertures 428A and 428B are enclosing the guard bolt 455 on the spool 452. In this manner, the first latch 426A and the second latch 426B can work in conjunction to secure the crop lifter apparatus 410 to the cutting header 450.

Securing flanges 429A, 429B can be provided on the first side edges 427A, 427B of the latches 426A and 426B, respectively. These securing flanges 429A, 429B can extend towards each other so that the securing flanges 429A, 429B secure the latches 426A, 426B against one another. Because the first latch 426A is positioned above the second latch 426B when the crop lifter apparatus 410 is attached to the cutter header 450, the securing flange 429A can extend downwards from the first side edge 427A so that it secures to the second latch 426B. However, the securing flange 429B attached to the second latch 426B can extend either upwards to secure the second latch 426B in place relative to the first latch 426A or downwards to secure the second latch 426B relative to the mounting member 416. Because the first latch 426A can have the securing flange 429A securing it relative to the second latch 426A, the second latch 42613 can have its securing flange 429B extending upwards securing both latches 426A, 426B around the spool 452. If the securing flange 429B is extending downwards, the first latch 426A is secured to the second latch 426B with the first securing flange 429A and the securing flange 429B on the second latch 426B therefore secures both latches 426A, 426B relative to the guard flange 416.

By having two latches 426A, 426B, both these latches can have apertures 428A, 428B that extent through their respective side edges 427A, 427B, yet when they are positioned to secure the crop lifter apparatus 410 to the cutting header 450, the latches 426A, 426B work in conjunction to completely encircle the spool 252.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A crop lifter apparatus adapted for attachment to a cutting header, the apparatus comprising:
a guard member having a slot passing through a rear end of the guard member;
a latch member pivotally attached at a first end to the guard member and having an aperture for receiving a guard bolt on the cutting header, the aperture passing through a side edge of the latch member;
a ski member operatively attached to the guard member; and
a lifting arm attached to the ski member,
wherein the apparatus can be attached to a cutting header by pivoting the latch member to an open position and inserting a guard bolt in the slot in the guard member, then pivoting the latch member to a closed position with the guard bolt received in the aperture in the latch member.

2. The apparatus of claim 1 wherein the latch member is pivotally attached to the guard member so that the latch member pivots in a plane lying substantially parallel to the guard member

3. The apparatus of claim 1 wherein the ski member has a bottom surface configured to ride along a ground surface.

4. The apparatus of claim 3 wherein the lifting arm extends rearward from the front end of the ski member back and over a knife of the cutting header when the apparatus is attached to the cutting header.

5. The apparatus of claim 1 wherein the latch can be pivoted between an open position with the second end of the latch positioned away from the guard member and a closed position with the second end of the latch positioned over top of the guard member.

6. The apparatus of claim 5 wherein the latch and the aperture in the latch are positioned relative to the guard member so that the slot in the guard member and the aperture in the latch align when the latch is placed in the closed position.

7. The apparatus of claim 1 wherein the latch has a flange on the side edge.

8. The apparatus of claim 1 wherein the guard member is operatively attached to the ski member by a ski mounting plate.

9. The apparatus of claim 1 wherein the guard member is operatively attached to the ski member by the ski member being directly attached to the guard member.

10. The apparatus of claim 1 wherein the guard member attaches to the guard bolt below a guard finger on the cutting header.

11. The apparatus of claim 1 wherein the guard member attaches to the guard bolt above a guard finger on the cutting header.

12. The apparatus of claim 1 wherein the guard bolt attaches a spool having a groove to the cutting header and wherein the guard member attaches to the spool.

13. The apparatus of claim 12 wherein the guard member attaches to the spool by the slot on the guard member sliding into the groove on the spool.

14. The apparatus of claim 13 wherein the latch pivots over top of the spool when the latch is placed into the closed position.

15. The apparatus of claim 1 further comprising a securing member having a first aperture for receiving a pin on the guard member and a second aperture for receiving the guard bold.

16. The apparatus of claim 15 wherein the securing member can be positioned between the latch member and the guard member when the latch member is positioned in the closed position and the apparatus is attached to the cutting header.

17. The apparatus of claim 1 wherein there is a first latch member and a second latch member with both the first latch member and the second latch member pivotally connected to the guard member, the first latch member having a first aperture and the second latch member having a second aperture, and wherein the first latch member and the second latch member are pivotable between an open position where the first aperture in the first latch member and the second aperture in the second latch member moved away from the guard member and a closed position where the apertures aligned with the slot in the guard member.

18. The apparatus of claim 17 wherein the first aperture in the first latch member passes through a side edge of the first latch member and the second aperture in the second latch member passes through a side edge of the second latch member so that the side edge of the first latch member is moved towards the side edge of the second latch member when the first latch member and the second latch member are pivoted from their open position to their closed position.

19. The apparatus of claim 17 wherein the first latch and the second latch are pivotally connected to the guard member by a single pivot point.

20. The apparatus of claim 17 wherein the second latch member is provided between the guard member and the first latch member when the first latch member and the second latch member are in the closed position.
